(19) United States
(12) Patent Application Publication
(10) Pub. No.: US 2008/0036972 A1
(43) Pub. Date: Feb. 14, 2008

(54) LED MOSAIC

(75) Inventors: William E. Phillips III, Cincinnati, OH (US); Jennifer L. Grace, Lakeside Park, KY (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/831,198

(22) Filed: Jul. 31, 2007

Related U.S. Application Data
(60) Provisional application No. 60/820,883, filed on Jul. 31, 2006.

(51) Int. Cl. G03B 21/00

(52) U.S. Cl. 353/31

(57) ABSTRACT

An illumination system for illuminating a target area includes an LED source, a collection lens that collects light from the LED source, and an image-forming device positioned at the target area. The LED source includes a mosaic of LED dies forming a footprint of at least two different colors.

### CROSS-REFERENCE TO RELATED APPLICATION

The present application is based on and claims the benefit of U.S. provisional patent application Ser. No. 60/820,883, filed Jul. 31, 2006, the content of which is hereby incorporated by reference in its entirety.

### BACKGROUND

Projection systems used for projecting an image on a screen can use multiple color light sources, such as light emitting diodes (LED's), with different colors to generate the illumination light. Several optical elements are disposed between the LED's and an image display unit to combine and transfer the light from the LED's to the image display unit. The image display unit can use various methods to impose an image on the light. For example, the image display unit may use absorption, as with a photographic slide, polarization, as with a liquid crystal display, or by the deflection of light, as with a micromechanical array of individually addressable, tiltable mirrors. Some image display units use transmissive display mechanisms and other image display units use reflective display mechanisms.

Providing uniform illumination of colors on the image display unit can be an important parameter of a projection system to make collecting, combining, homogenizing and delivering the light to the image display unit more efficient.

### SUMMARY

An illumination system for illuminating a target area includes an LED source, a light mixer, a collection lens that collects light from the LED source, and an image-forming device positioned at the target area. The LED source includes a mosaic of LED dies forming a footprint of at least two different colors.

### BRIEF DESCRIPTION OF THE FIGURES

FIG. 1 is a schematic diagram of a projection subsystem.

FIG. 2A is a schematic diagram of a projection subsystem that includes an anamorphic optical device.

FIG. 2B is a schematic diagram of a projection subsystem that includes an anamorphic surface on a refractive body.

FIG. 3 is a schematic diagram of a projection subsystem that includes a light mixer attachment which creates uniform intensity and color.

FIG. 4 is a schematic diagram of another projection subsystem.

FIGS. 5A-5F illustrates mosaic arrangements of LED dies on a substrate.

FIG. 5G illustrates a uniform illumination profile.

FIG. 6 illustrates a Bayer pattern multi-color LED array design.

### DETAILED DESCRIPTION

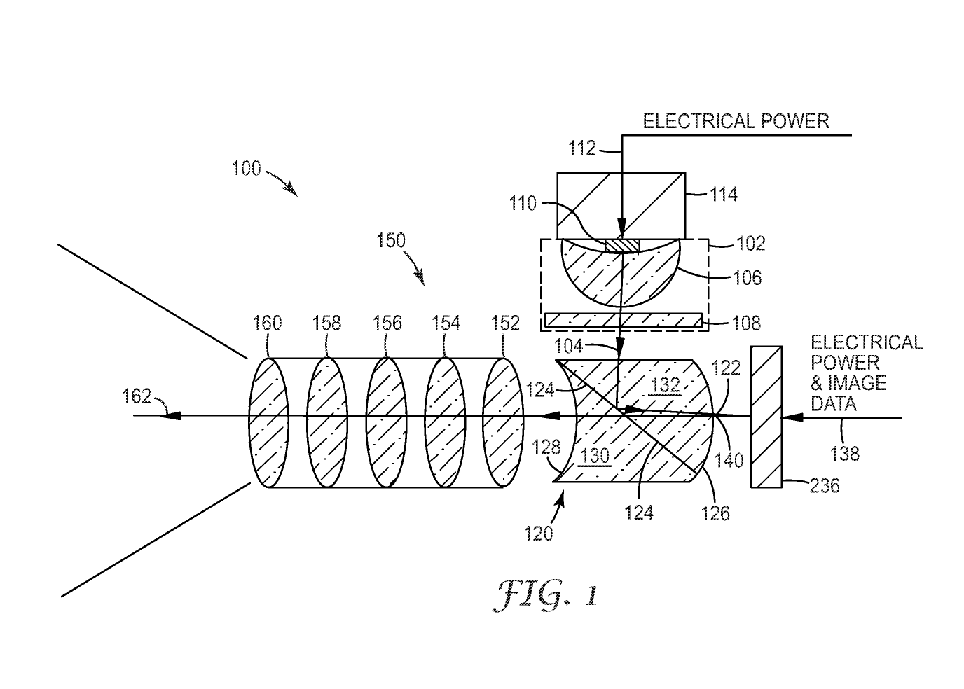

FIG. 1 illustrates a projection subsystem 100. The projection subsystem 100 is useful for projecting still or video images from miniature electronic systems such as cell phones, personal digital assistants (PDA's), global positioning system (GPS) receivers and the like. Projection subsystem 100 receives electrical power and image data from the miniature electronic system (not illustrated in FIG. 1) into which it is embedded. Projection subsystem 100 is useful as a component part of a miniature projector accessory for displaying computer video. Projection subsystem 100 is useful in systems that are small enough to be carried, when not in use, in a pocket of clothing, such as a shirt pocket. Images projected by the projection subsystem 100 can be projected onto a reflective projection screen, a light-colored painted wall, a whiteboard or sheet of paper or other known projection surfaces. Projection subsystem 100 can be embedded in a portable computer such as a laptop computer or a cell phone.

Projection subsystem 100 comprises a light engine 102 that provides a light beam 104. The light engine 102 includes a collection lens 106, a collimator 108 and a solid state light emitter 110. According to one aspect of subsystem 100, the collection lens 106 comprises a hyperhemispheric ball lens. The collection lens 106 may be as described in commonly assigned U.S. application Ser. No. 11/322,801 “LED With Compound Encapsulant Lens” (Attorney Docket No. 61677US002), filed Dec. 30, 2005, or as described in U.S. Application entitled “LED Source With Hollow Collection Lens” (Attorney Docket No. 62371US006), filed on even date herewith, all incorporated herein by reference. The collimator 108 can comprise a focusing unit comprising a first Fresnel lens having a first non-faceted side for receiving a first non-collimated beam and a first faceted side for emitting the collimated beam; and a second Fresnel lens having a second non faceted side for substantially directly receiving the collimated beam and second faceted side for emitting an output beam.

The solid state light emitter 110 receives electrical power 112 with an electrical power level and is thermally coupled to a heat sink 114. The solid state light emitter 110 provides an emitter light beam with an emitter luminous flux level. According to one aspect of subsystem 100, the light beam 104 comprises incoherent light. According to another aspect, the light beam 104 comprises illumination that is a partially focused image of the solid state light emitter 110. According to yet another aspect, the solid state light emitter 110 comprises one or more light emitting diodes (LED's). In this case, solid state light emitter 110 can include a mosaic of LED dies, such as red, green, and blue LED dies, or any other arrangement of distinct LED dies (collectively referred to as an LED source). The mosaic can be packaged and optionally encapsulated on the same substrate. The mosaic can form a shape or footprint, as defined by an outer boundary of the dies, in different configurations. For example, the shape can be substantially similar to optical components positioned to receive light from solid state light emitter 110. In one example, an aspect ratio of the shape can be chosen to be similar to one or more optical components that receive light from the mosaic.

The mosaic of LED dies can be used for non-sequential illumination, where white light supplied by the illumination system is not a time sequence of individual primary colors, but where the primary colors are projected simultaneously, as with a white light emitting phosphor-based LED source; or for sequential illumination, where white light supplied by the illumination system is in the form of a time sequence of individual primary colors, the time-average of which appears white to the ordinary observer. In the non-sequential case, the digital imaging device can include a colored filter to define different colored sub-pixels of the image, whereas in the sequential case, the colored filter can be eliminated, because a given pixel on the imaging device can provide color information depending on its relative state when illuminated by the different colors at different times.

The projection subsystem 100 also includes a refractive body 120. The refractive body 120 receives the light beam 104 and provides a polarized beam 122. The refractive body 120 includes an internal polarizing filter 124. One polarized component of the light beam 104 is reflected by the internal polarizing filter 124 to form the polarized beam 122. The refractive body can be formed or utilized according to one or more aspects of US Patent Publication US 2007/0023941 A1 Duncan et al., US Patent Publication US 2007/0024981 A1 Duncan et al., US Patent Publication US 2007/0085973 A1 Duncan et al., and US Patent Publication US 2007/0030456 Duncan et al., all of which are hereby incorporated by reference in their entirety.

The refractive body 120 comprises a first external lens surface 126 and a second external lens surface 128. The external lens surfaces 126, 128 have curved lens surfaces and have non-zero lens power. The external lens surface 126 can comprise a convex lens surface that can be useful in maintaining a small volume for the projection subsystem 100. According to another aspect, the external lens surfaces 126, 128 are flat. The refractive body 120 can include plastic resin material bodies 130, 132 on opposite sides of the internal polarizing filter 124. The internal polarizing filter 124 can include a multilayer optical film, in one example. If desired, the refractive body 120 can comprise a multifunction optical component that functions as a polarizing beam splitter as well as a lens. By combining the polarizing beam splitter and lens functions in a multifunction refractive body, losses that would otherwise occur at air interfaces between separate beam splitters and lenses can be avoided.

The projection subsystem 100 also includes an image-forming device 136. The image-forming device 136 receives image data on electrical input bus 138. The image-forming device 136 receives the polarized beam 122 and selectively reflects the polarized beam 122 according to the image data to form an image 140. The image-forming device 136 provides the image 140 with a polarization that is rotated relative to the polarization of the polarized beam 122 to the refractive body 120. The image 140 then passes through the internal polarizing filter 124. According to one aspect of subsystem 100, the image-forming device 136 comprises a liquid crystal on silicon (LCOS) device. An aspect ratio of the image-forming device 136 can be adapted to be substantially similar to an aspect ratio of an LED mosaic for solid state light emitter 110.

The projection subsystem 100 further includes a projection lens assembly 150 that receives the image 140 from the refractive body 120. The projection lens assembly 150 comprises multiple lenses indicated schematically at 152, 154, 156, 158, 160. The projection lens assembly 150 provides an image projection beam 162 having a projected luminous flux that is suitable for viewing.

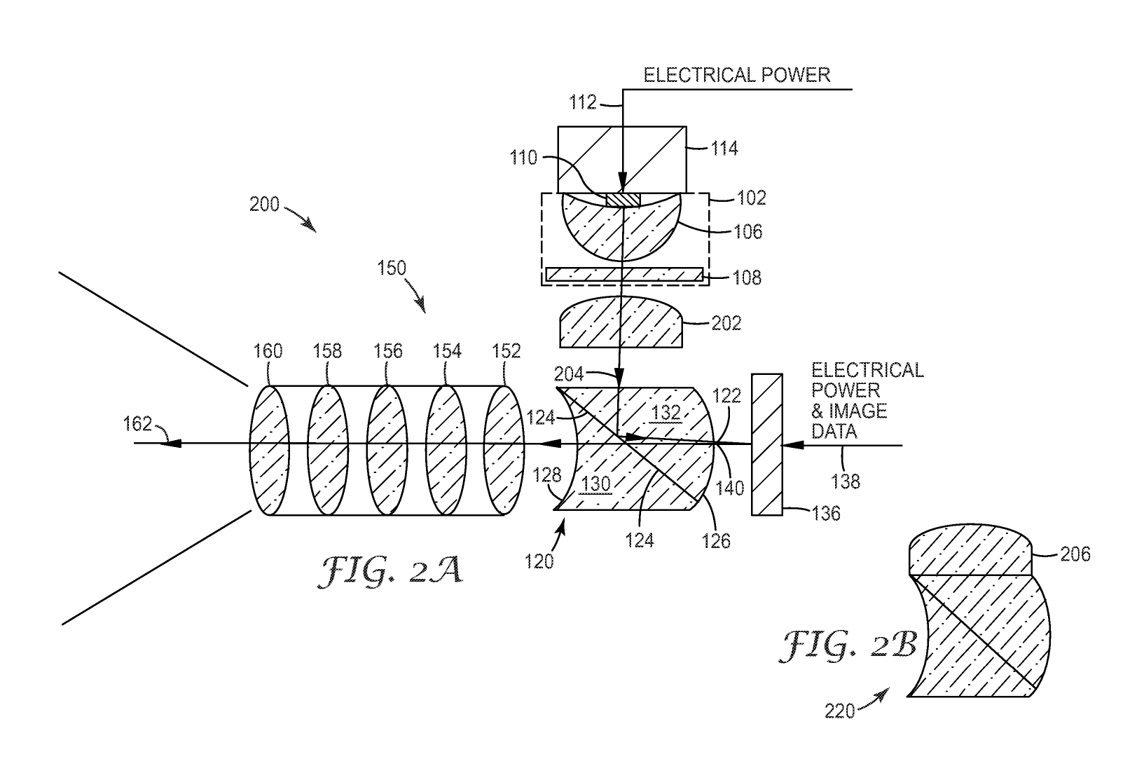

FIG. 2A illustrates a projection subsystem 200. Projection subsystem 200 is similar to projection subsystem 100 except that an anamorphic optical device 202 is included in the projection subsystem 200. Reference numbers used in FIG. 2A that are the same as reference number used in FIG. 1 represent the same or similar features. In other respects, the projection subsystem 200 is similar to projection subsystem 100. The anamorphic optical device 202 alters an aspect ratio of a light beam 204. The anamorphic optic device 202 changes light beam shape to adapt a first aspect ratio in the light engine 102 to a second different aspect ratio in the refractive body 120. In one embodiment, the first aspect ratio is 1:1 and the second aspect ratio is 16:9. In another embodiment, the first aspect ratio is 1:1 and the second aspect ratio is 4:3. According to one aspect, the second aspect ratio can be adapted to match an aspect ratio of the image forming device 136. The anamorphic optical device 202 can comprise an anamorphic lens as illustrated in FIG. 2A. In another embodiment illustrated in FIG. 2B, an anamorphic surface 206 provided on a refractive body 220 serves as an anamorphic optical device. In other respects, the refractive body 220 is similar to the refractive body 120 in FIG. 2A.

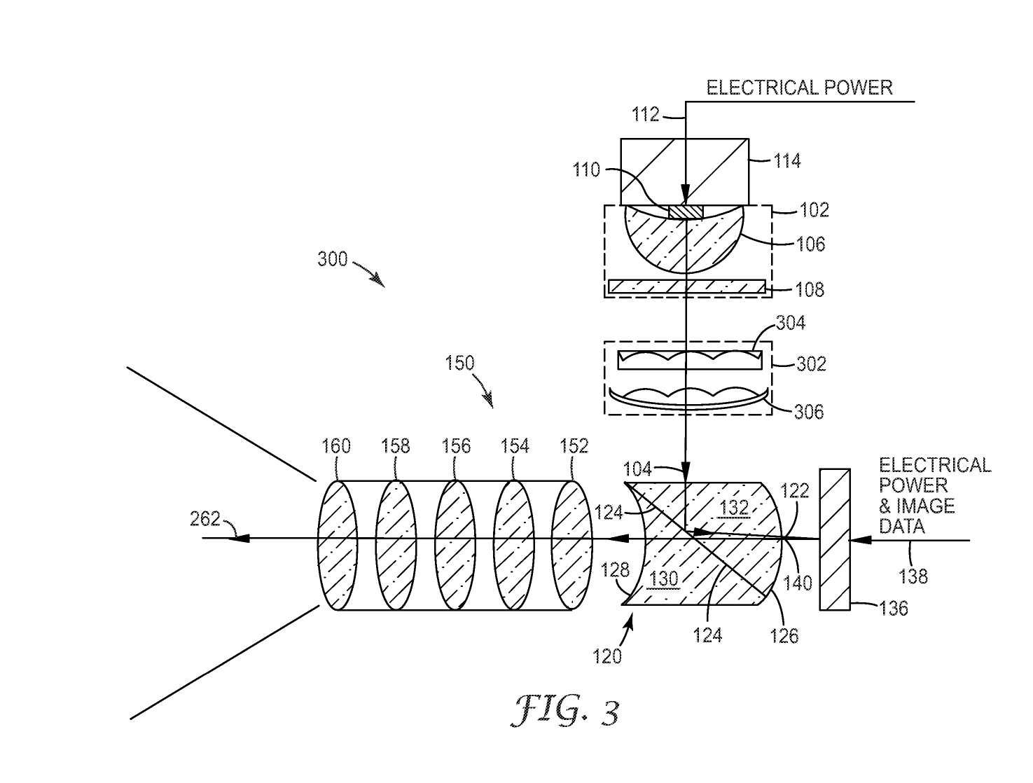

FIG. 3 illustrates a projection subsystem 300. Projection subsystem 300 is similar to projection subsystem 100 except that a light mixer attachment 302 is included in the projection subsystem 300. Reference numbers used in FIG. 3 that are the same as reference number used in FIG. 1 represent the same or similar features. In other respects, the projection subsystem 300 is similar to projection subsystem 100. The light mixer attachment 302 includes a pair of lenslet arrays 304, 306 (also known as fly-eye lens arrays) that mix (e.g., homogenize) light from the individual dies of the solid state light emitter 110 onto an illuminated target area, namely image-forming device 136. Such light is then reflected by the image-forming device 136 so that it can be directed through projection lens assembly 150 for viewing.

Use of a lenslet array as a light mixing device can help preserve the etendue of solid state light emitter 110 such that losses in brightness from the solid state light emitter 110 to the image-forming device 136 are small. In addition, intensity at corner areas of the image-forming device 136 can be maintained. In one example, the lenslet arrays are 3×3 lenslet arrays, each array containing a total of 9 lenslets arranged in a grid. It can be desirable to keep the physical size of each of the two lenslet arrays 302, 304 no larger than about the size of the image forming device 136. Furthermore, the size (e.g. the length of a side or diagonal) of a given lenslet in either of the lenslet arrays can be about one-third of the corresponding size of the entire target area or digital imaging device. The shape or footprint of the mosaic of LED dies for solid state light emitter 110 can be made to match an aperture for each of the lenslet arrays 304, 306 accurately so that the etendue of the source can be better maintained throughout the system.

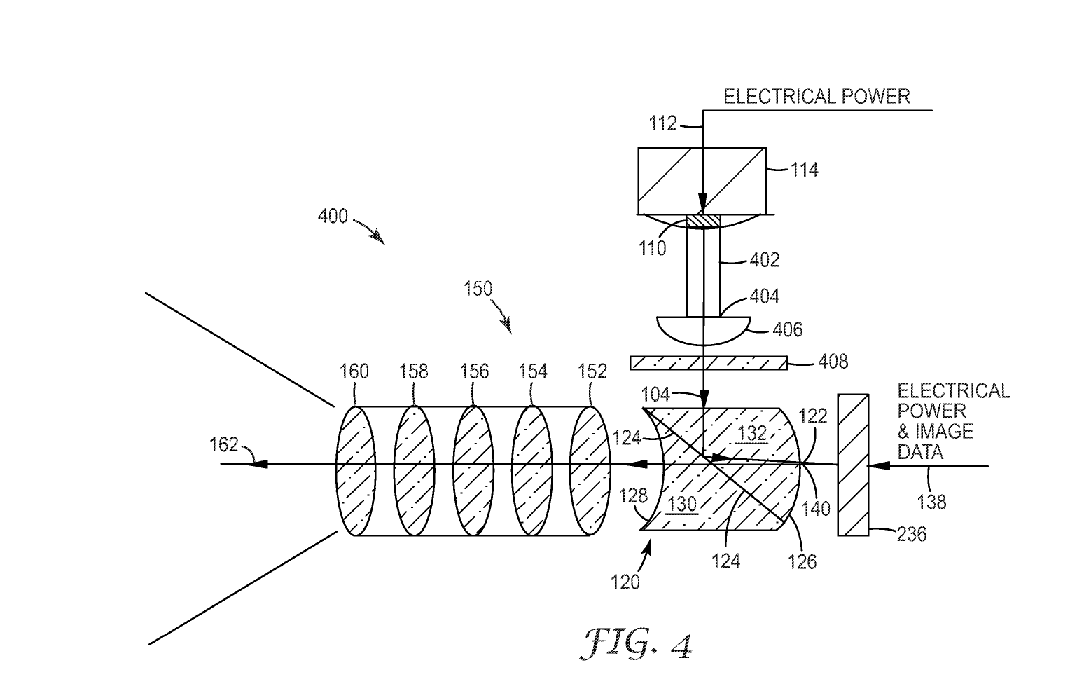

FIG. 4 illustrates a projection subsystem 400. Projection subsystem is similar to projection subsystem 100 except that a integrator rod/tunnel is used as the light mixer in the subsystem 400. For example, the subsystem 400 may employ a tapered integrator rod/tunnel as described in U.S. Application “Integrating Light Source Module” (Attorney Docket No. 62382 US008) filed on even date herewith, the contents of which are hereby incorporated by reference in its entirety. Projection subsystem 400 includes an integrator 402, recycling filter 404, optic 406 and an optional condenser lens 408. The integrator 402 reflects light of its sides toward filter 404 and optic 406. If used, condenser lens 408 sends light to refractive body 120. The height of integrator 402 can be varied as desired.

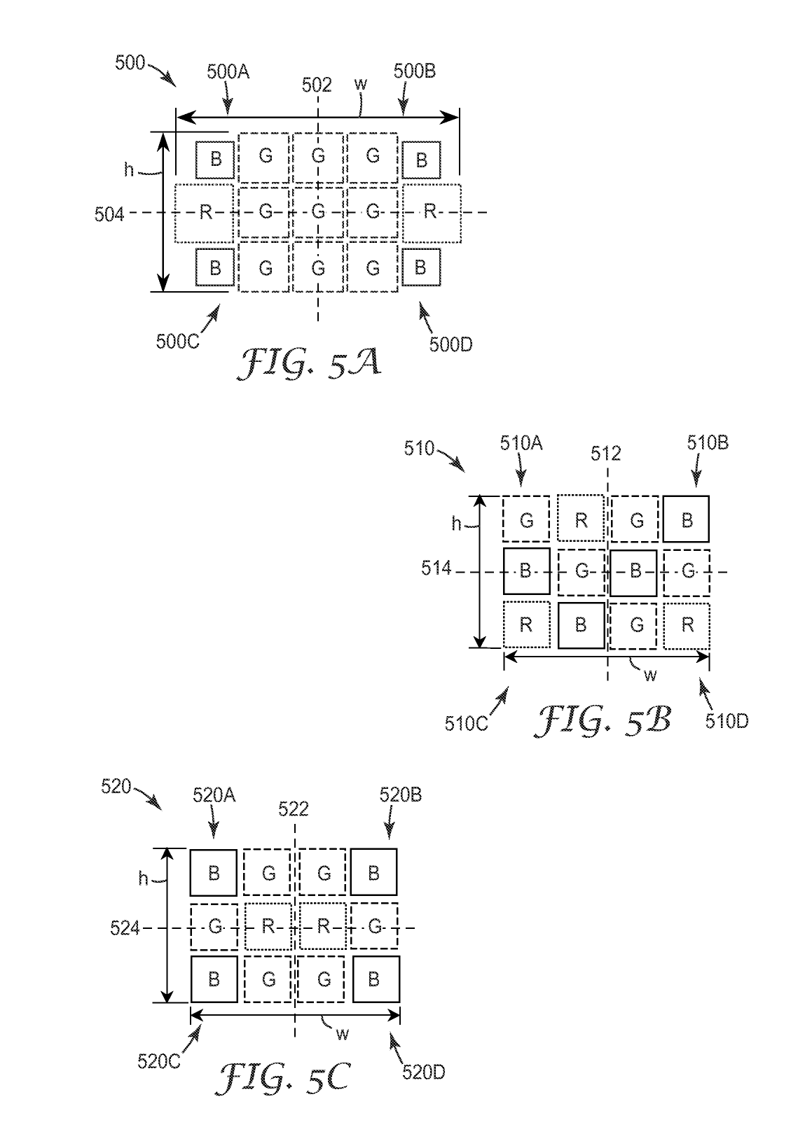

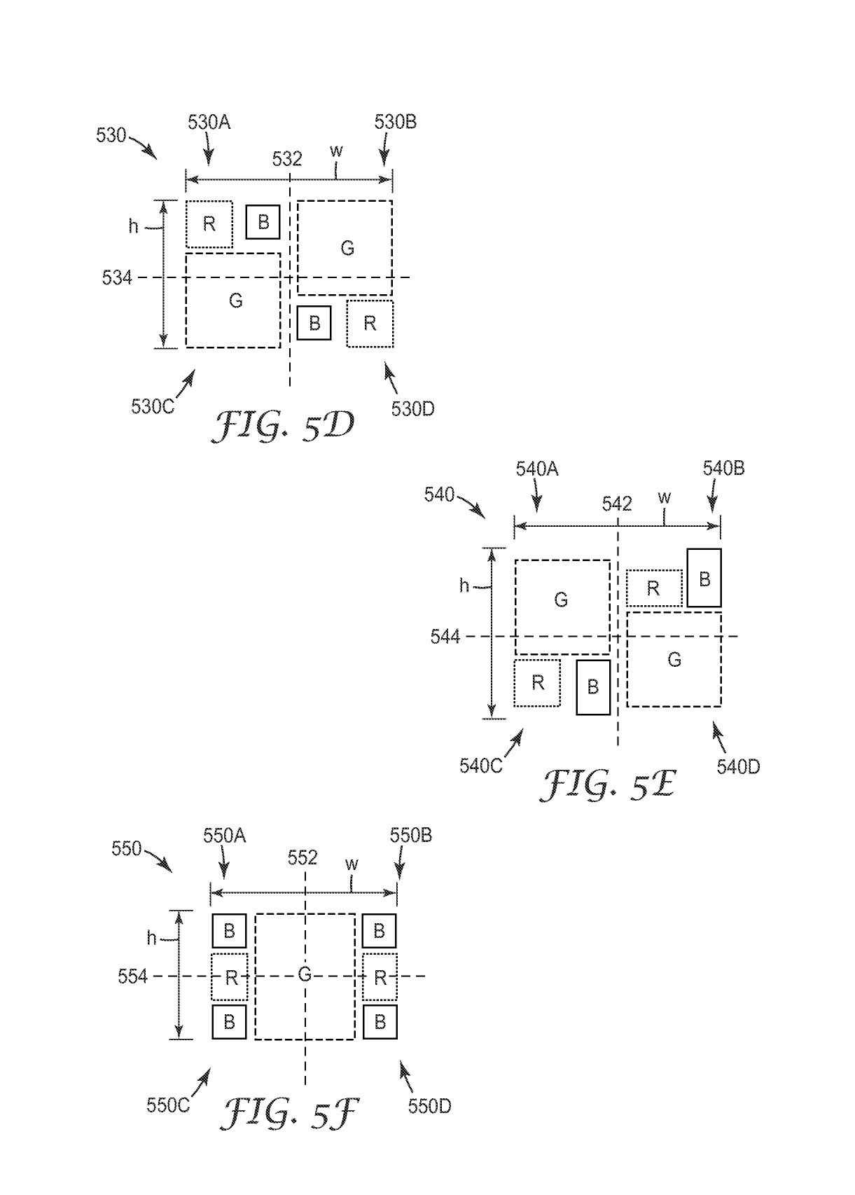

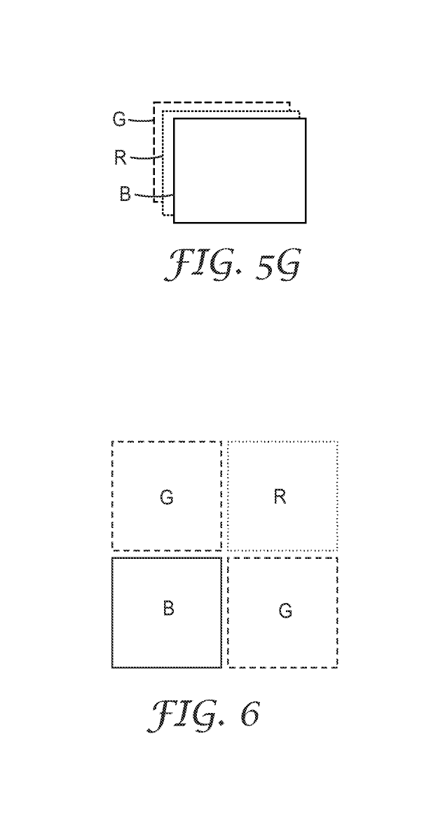

FIGS. 5A-F show example LED mosaic arrangements that can be implemented in solid state light emitter 110. Non-emitting (dark) spaces or gaps can exist between adjacent LED dies, producing a highly non-uniform brightness within the footprint defined by the mosaic. As illustrated, each arrangement includes at least one red-emitting LED die, at least one green-emitting LED die, and at least one blue-emitting LED die. A mixture of these primary colors can produce white light, but other color mixtures can also be used to produce white light, and are contemplated herein. Further, for applications that do not require white light or that in fact require a particular color of light other than white, mosaics of LED dies of less than three emitted colors or LED dies that all emit the same color may be used.

The LED dies may be arranged symmetrically, as in FIGS. 5A, 5C and 5F, or asymmetrically, as in FIGS. 5B, 5D and 5E. Symmetrical is defined as having consistent configuration of LED dies on opposite sides of a line or about an axis. Additionally, the LED dies may all be the same size and shape, as in FIGS. 5B and 5C, or they may have different sizes and/or shapes as in FIGS. 5A, 5D, 5E and 5F. For example, the green dies can be adjusted to cover a larger surface area than the blue and red dies. When split into quadrants about a horizontal center line and a vertical centerline, at least two of the quadrants for the mosaics in FIGS. 5A-5F have at least two different colors. It can also be beneficial for quadrants that are diagonal from one another to have the same colors to enhance uniformity.

For projection systems, it can be desirable for the shape or footprint of the mosaic to be generally rectangular, optionally, having the same or similar aspect ratio as that of image-forming device 136. An aspect ratio for the mosaic arrangements defined as the width of the mosaic divided by the height of the mosaic, can be adjusted as desired, for example providing an aspect ratio of 4:3 or 16:9. In one example, the mosaics in FIGS. 5A-F can be of a size that is in a range from around 1.20 to 1.75 mm×0.75 to 1.25 mm in size, which can be useful in certain mini projector systems, but should not be interpreted as limiting. FIG. 5G shows (in exploded view) an illumination profile that is desired at the target area for the mosaics of FIGS. 5A-F. That is, the illumination profile at the target area is uniformly red, green, and blue, whether simultaneously or sequentially, so that a uniformly white illumination profile over the target area (e.g. image forming device 136) results.

FIG. 5A illustrates a mosaic 500 having a footprint defined by a width ‘w’ and a height ‘h’. Mosaic 500 includes a total of 15 separate dies spaced apart from one another that include three separate colors, denoted as R for red, G for green and B for blue. There are 9 G dies, 4 B dies and 2 R dies. Other colors for the dies may also be used. The footprint of mosaic 500 can be divided into quadrants 500A-D as identified by axes 502 and 504. Each of the quadrants 500A-D include at least a portion of all three colors. For example, quadrant 500A includes a full B die, a full G die and three partial G dies and a partial R die. Additionally, mosaic 500 is symmetric about both axes 502 and 504, as well as about an axis positioned at the intersection of axes 502 and 504. The R dies are larger than each of the other dies in mosaic 500 and the G dies are larger than the B dies in mosaic 500. Additionally, the area covered by the G dies is larger than the area covered by the B or R dies.

FIG. 5B illustrates a mosaic 510 having a footprint defined by a width ‘w’ and a height ‘h’. Mosaic 510 includes a total of 12 separate dies spaced apart from one another and include three separate colors, denoted as R for red, G for green and B for blue. There are 5 G dies, 4 B dies and 3 R dies. Other colors for the dies may also be used. The footprint of mosaic 510 can be divided into quadrants 510A-D as identified by axes 512 and 514. Each of the quadrants 510A, C and D include at least a portion of all three colors. For example, quadrant 500A includes a full R die, a full G die and partial B and G dies. Quadrant 510B includes a full G die, a full B die and partial B and G dies. Additionally, mosaic 510 is asymmetric about both axes 512 and 514, as well as about an axis at the intersection of axes 512 and 514. Each of the dies are the same size within mosaic 510.

FIG. 5C illustrates a mosaic 520 having a footprint defined by a width ‘w’ and a height ‘h’. Mosaic 520 includes a total of 12 separate dies spaced apart from one another and include three separate colors, denoted as R for red, G for green and B for blue. There are 6 G dies, 4 B dies and 2 R dies. Other colors for the dies may also be used. The footprint of mosaic 520 can be divided into quadrants 520A-D as identified by axes 522 and 524. Each of the quadrants 520A-D include at least a portion of all three colors. For example, quadrant 520A includes a full B die, a full G die and partial R and G dies. Additionally, mosaic 520 is symmetric about both axes 522 and 424, as well as about an axis at the intersection of axes 522 and 524. Each of the dies are the same size within mosaic 520.

FIG. 5D illustrates a mosaic 530 having a footprint defined by a width ‘w’ and a height ‘h’. Mosaic 530 includes a total of 6 separate dies spaced apart from one another and include three separate colors, denoted as R for red, G for green and B for blue. There are 2 G dies, 2 B dies and 2 R dies. Other colors for the dies may also be used. The footprint of mosaic 530 can be divided into quadrants 530A-D as identified by axes 532 and 534. Each of the quadrants 530A and D include at least a portion of all three colors. For example, quadrant 530A includes a full B die, a full R die and a partial G die. Each of the quadrants 530B and C include only a partial G die. Additionally, mosaic 530 is asymmetric about both axes 532 and 534. The mosaic 530 is symmetric about an axis at the intersection of axis 532 and 534, wherein the same configuration of dies will result if mosaic 530 is rotated 180° about the axis at the intersection of axes 532 and 534. Each of the 2 G dies are larger than the R and B dies. Additionally, the R dies are larger than the B dies.

FIG. 5E illustrates a mosaic 540 having a footprint defined by a width ‘w’ and a height ‘h’. Mosaic 540 includes a total of 6 separate dies spaced apart from one another and include three separate colors, denoted as R for red, G for green and B for blue. There are 2 G dies, 2 B dies and 2 R dies. Other colors for the dies may also be used. The footprint of mosaic 540 can be divided into quadrants 540A-D as identified by axes 542 and 544. Each of the quadrants 540A and D include at least a portion of all three colors. For example, quadrant 540B includes a full B die, a full R die and a partial G die. Each of the quadrants 540A and D include only a partial G die. Additionally, mosaic 540 is asymmetric about both axes 542 and 544. Each of the 2 G dies are larger than the R and B dies. Additionally, the R dies are larger than the B dies.

FIG. 5F illustrates a mosaic 550 having a footprint defined by a width ‘w’ and a height ‘h’. Mosaic 550 includes a total of 7 separate dies spaced apart from one another and includes three separate colors, denoted as R for red, G for green and B for blue. There are 4 B dies, 2 R dies and 1 G die. Other colors for the dies may also be used. The footprint of mosaic 550 can be divided into quadrants 550A-D as identified by axes 552 and 554. Each of the quadrants 550A and D include at least a portion of all three colors. For example, quadrant 520A includes a full B die, a partial R die and a partial G die. The mosaic 550 is symmetric about both axes 552 and 554, as well as about an axis at the intersection of axis 552 and 554, wherein the same configuration of dies will result if mosaic 550 is rotated 180° about the axis at the intersection of axes 552 and 554. The G die is larger than the R and B dies. Additionally, the R dies are larger than the B dies. The size of each of the dies can be adjusted in order to effect the uniformity of the subsystem. For example, the R, G and B dies can be adjusted in a direction of axis 554 (adjusting width) and the R and B dies can be adjusted in a direction of axis 552 (adjusting length).

Color uniformity can be defined in color primary space by red(R), green(G) and blue(B), where R, G and B have values between 0 and 255. The color uniformity U is defined in this space as U=(ΔR²+ΔG²+ΔB²)^{1/2}, where ΔR is the maximum difference between values of red in the four corners, ΔG is the maximum difference between the values of green in the four corners, and ΔB is the maximum difference between the values of blue in the four corners. Lower values of U represent greater color uniformity. The arrangement of the dies can be adjusted to maximize the uniformity.

Color uniformity U is determined for LED arrangements shown in FIGS. 5E, 5F, and 6 in conjunction with the illumination subsystem of FIG. 4. The data are summarized in the table below, where the integrator 402 is varied in length. FIG. 6 illustrates the common Bayer LED arrangement.

| Length of Integrator(mm) | Die Arrangement | U |
|---|---|---|
| 2.5 | | 12.6 |
| 2.5 | | 4.4 |
| 2.5 | | 3.5 |
| 3.0 | | 8.7 |
| 3.6 | | 6.3 |

For integrator length 2.5 mm, the data indicates LED arrangements FIGS. 5E and 5F give superior color uniformity. In order to get comparable color uniformity with the traditional Bayer LED arrangement, the integrator would have to be at least 1.1 mm longer. In general, the use of symmetry reduces the length of the required integrator 402. A shorter integrator can also improve illumination efficiency because fewer reflections are required inside the integrator.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An illumination system for illuminating a target area, the system comprising:
an LED source that includes a mosaic of LED dies forming a footprint, the footprint being divided into four quadrants about a vertical centerline and a horizontal centerline, wherein for at least two quadrants, there are at least two different colors of LED dies in the at least two quadrants;
a collection lens that collects light from the LED source; and
an image-forming device that receives light from the LED source at the target area.

2. The system of claim 1, wherein the at least two quadrants are diagonal from one another.

3. The system of claim 1, wherein the at least two quadrants include at least three different colors of LED dies.

4. The system of claim 1, wherein the footprint has an aspect ratio that substantially matches an aspect ratio of the target area.

5. The system of claim 1, wherein the LED dies have at least two different sizes.

6. The system of claim 5, wherein the LED dies have three different sizes for three different colors.

7. The system of claim 1, wherein the LED dies include at least three dies that emit light of different colors.

8. The system of claim 7, wherein the different colors include red, green and blue.

9. The system of claim 1, wherein the system provides sequential illumination.

10. The system of claim 1, wherein the system provides non-sequential illumination.

11. The projection system of claim 1, wherein the image-forming device a liquid crystal on silicon device.

12. The system of claim 1, and further comprising a projection lens assembly receiving an image from the image-forming device.

13. The system of claim 1 wherein the mosaic is symmetric about at least one of the vertical centerline and the horizontal centerline.

14. The system of claim 1 wherein the mosaic is asymmetric about at least one of the vertical centerline and the horizontal centerline.

15. The system of claim 1 wherein the mosaic is symmetric about an axis positioned at an intersection of the vertical centerline and the horizontal centerline.

16. The system of claim 1 wherein the mosaic includes at least five dies.

17. The system of claim 16 wherein the mosaic includes at least two dies for each of three different colors.
